(19) United States
(12) Patent Application Publication
(10) Pub. No.: US 2024/0155445 A1
(43) Pub. Date: May 9, 2024

(54) METHOD OF CONFIGURING HANDOVER USING PHYSICAL LAYER AND MAC LAYER SIGNALING IN NEXT GENERATION MOBILE COMMUNICATION SYSTEM

(71) Applicant: Samsung Electronics Co., Ltd., Suwon-si (KR)

(72) Inventors: June HWANG, Suwon-si (KR); Seungri JIN, Suwon-si (KR)

(21) Appl. No.: 18/500,585

(22) Filed: Nov. 2, 2023

(30) Foreign Application Priority Data
Nov. 3, 2022 (KR) 10-2022-0145034

(51) Int. Cl. H04W 36/00

(52) U.S. Cl. CPC H04W 36/0061; H04W 36/0083

(57) ABSTRACT

The disclosure relates to a fifth generation (5G) or sixth generation (6G) communication system to support a data transmission rate higher than before. A method performed by a terminal in a wireless communication system is provided. The method includes receiving, from a base station, a radio resource control (RRC) message including lower layer triggered mobility (LTM) configuration information, the LTM configuration information being associated with at least one RRC reconfiguration, receiving, from the base station, a medium access control (MAC) control element (CE) for triggering a LTM handover, the MAC CE including an identifier (ID) corresponding to one of the at least one RRC reconfiguration, and performing the LTM handover to a target cell based on the one of the at least one RRC reconfiguration.

### CROSS-REFERENCE TO RELATED APPLICATION(S)

This application is based on and claims priority under 35 U.S.C. § 119(a) of a Korean patent application number 10-2022-0145034, filed on Nov. 3, 2022, in the Korean Intellectual Property Office, the disclosure of which is incorporated by reference herein in its entirety.

### BACKGROUND

### 1. Field

The disclosure relates to operation of a user equipment (UE) and a network in a mobile communication system. More particularly, the disclosure relates to an operation of configuring and performing handover based on layer 1 or 2.

### 2. Description of Related Art

Fifth generation (5G) mobile communication technologies define broad frequency bands such that high transmission rates and new services are possible, and can be implemented not only in “Sub 6 gigahertz (GHz)” bands, such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G.

In the initial state of 5G mobile communication technologies, in order to support services and to satisfy performance requirements in connection with enhanced mobile broadband, (eMBB), ultra reliable & low latency communications (URLLC), and massive machine-type communications (mMTC), there has been ongoing standardization regarding beamforming and massive multiple-input multiple-output (MIMO) for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large-capacity data transmission and a polar code for highly reliable transmission of control information, L2 pre-processing, and network slicing for providing a dedicated network customized to a specific service.

Currently, there is ongoing discussion regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN) which is UE-satellite direct communication for securing coverage in an area in which communication with terrestrial networks is impossible, and positioning.

Moreover, there has been ongoing standardization in wireless interface architecture/protocol fields regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service fields regarding a 5G baseline architecture (for example, service based architecture or service based interface) for combining network functions virtualization (NFV) and software-defined networking (SDN) technologies, and mobile edge computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for securing coverage in terahertz bands of 6G mobile communication technologies, full dimensional MIMO (FD-MIMO), multi-antenna transmission technologies, such as array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services can be provided, and accordingly there is a need for ways to effectively provide these services.

The above information is presented as background information only to assist with an understanding of the disclosure. No determination has been made, and no assertion is made, as to whether any of the above might be applicable as prior art with regard to the disclosure.

### SUMMARY

In case that a base station (BS) transfers an indication for performing handover to a user equipment (UE) via layer 1 or layer 2, application of other factors via radio resource control (RRC) is needed. A layer 1 or layer 2 signal has an insufficient signal size to transfer information associated with the all factors to be applied.

Aspects of the disclosure are to address at least the above-mentioned problem and/or disadvantages and to provide at least the advantages described below. Accordingly, an aspect of the disclosure is to provide a base station transfers most configuration information to a user equipment (UE) in advance, and transfers only limited information, such as identifier (ID) or index information via a layer 1 or layer 2 signal. Handover is performed by applying the configuration information of information transferred in advance that is associated with the corresponding ID or index value.

Additional aspects will be set forth in part in the description which follows and, in part, will be apparent from the description, or may be learned by practice of the presented embodiments.

In accordance with an aspect of the disclosure, a method performed by a terminal in a wireless communication system is provided. The method includes receiving, from a base station, an RRC message including lower layer triggered mobility (LTM) configuration information, the LTM configuration information being associated with at least one RRC reconfiguration, receiving, from the base station, a medium access control (MAC) control element (CE) for triggering a LTM handover, the MAC CE including an ID corresponding to one of the at least one RRC reconfiguration, and performing the LTM handover to a target cell based on the one of the at least one RRC reconfiguration.

In accordance with another aspect of the disclosure, a method performed by a base station in a wireless communication system is provided. The method includes transmitting, to a terminal, an RRC message including lower layer triggered mobility (LTM) configuration information, the LTM configuration information being associated with at least one RRC reconfiguration, and transmitting, to the terminal, a MAC CE for triggering a LTM handover to a target cell based on one of the at least one RRC reconfiguration, the MAC CE including an ID corresponding to the one of the at least one RRC reconfiguration.

In accordance with another aspect of the disclosure, a terminal in a wireless communication system is provided. The terminal includes a transceiver, and at least one processor coupled with the transceiver. The at least one processor is configured to receive, from a base station, an RRC message including lower layer triggered mobility (LTM) configuration information, the LTM configuration information being associated with at least one RRC reconfiguration, receive, from the base station, a MAC CE for triggering a LTM handover, the MAC CE including an ID corresponding to one of the at least one RRC reconfiguration, and perform the LTM handover to a target cell based on the one of the at least one RRC reconfiguration.

In accordance with another aspect of the disclosure, a base station in a wireless communication system is provided. The base station includes a transceiver, and at least one processor coupled with the transceiver, the at least one processor configured to transmit, to a terminal, an RRC message including lower layer triggered mobility (LTM) configuration information, the LTM configuration information being associated with at least one RRC reconfiguration, and transmit, to the terminal, a MAC CE for triggering a LTM handover to a target cell based on one of the at least one RRC reconfiguration, the MAC CE including an ID corresponding to the one of the at least one RRC reconfiguration.

According to an embodiment of the disclosure, by indicating, via a layer 1 or layer 2 signal, only predetermined information among configuration information that a network transfers in advance, a UE applies all configuration information needed when performing handover.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a structure of a general long term evolution (LTE) system according to an embodiment of the disclosure;

FIG. 2 is a diagram illustrating a radio protocol structure of a general LTE system according to an embodiment of the disclosure;

FIG. 3 is a diagram illustrating a structure of a next generation mobile communication system according to an embodiment of the disclosure;

FIG. 4 is a diagram illustrating a radio protocol structure of a next generation mobile communication system according to an embodiment of the disclosure;

FIG. 5 is a diagram of an internal structure of a user equipment (UE) according to an embodiment of the disclosure;

FIG. 6 is a diagram illustrating a configuration of a new radio (NR) base station according to an embodiment of the disclosure;

FIG. 7 is a diagram illustrating operation of a UE, a centralized unit (CU), and a distributed unit (DU) for a lower layer triggered mobility (LTM) operation according to an embodiment of the disclosure;

FIG. 8 is a diagram illustrating a case in which a configuration of a candidate cell corresponds to RRCReconfiguration according to an embodiment of the disclosure;

FIG. 9 is a diagram illustrating a case in which a configuration of a candidate cell corresponds to a cell group configuration according to an embodiment of the disclosure;

FIG. 10 is a diagram illustrating a case in which a configuration of a candidate cell corresponds to a cell group configuration, and common configuration information is maintained separately according to an embodiment of the disclosure;

FIG. 11 is a diagram illustrating a case in which a configuration of a candidate cell corresponds to a cell configuration according to an embodiment of the disclosure; and

FIG. 12 is a diagram illustrating a case in which a configuration of a candidate cell corresponds to a cell configuration, and common configuration information is maintained separately according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or long term evolution advanced (LTE-A) systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, or other similar services. In addition, based on determinations by those skilled in the art, the embodiments of the disclosure may also be applied to other communication systems through some modifications without significantly departing from the scope of the disclosure. Herein, it will be understood that each block of the flowchart illustrations, and combinations of blocks in the flowchart illustrations, can be implemented by computer program instructions.

These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved. As used herein, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more central processing units (CPUs) within a device or a security multimedia card. Furthermore, the “unit” in the embodiments may include one or more processors.

In the following description of the disclosure, terms and names specified in the 5GS and NR standards, which are the latest standards defined by the 3^{rd} generation partnership project (3GPP) group among the existing communication standards, will be used for the sake of descriptive convenience. However, the disclosure is not limited by these terms and names, and may be applied in the same way to systems that conform other standards. For example, the disclosure may be applied to 3GPP 5GS/NR (5th generation mobile communication standards).

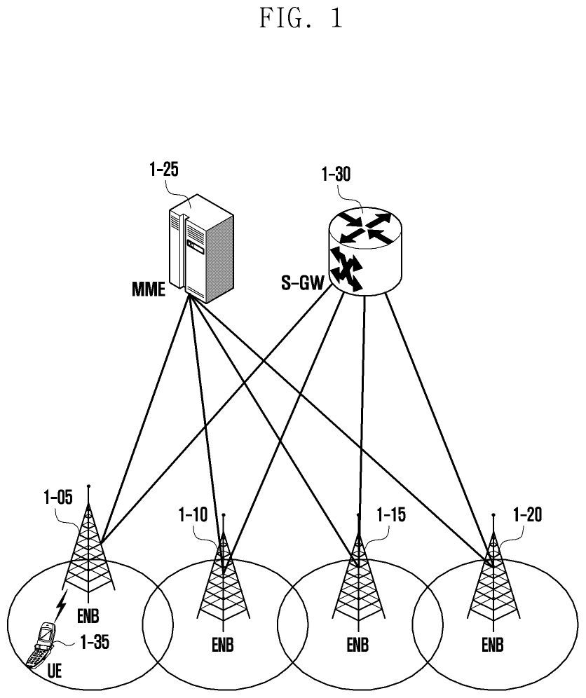

FIG. 1 is a diagram illustrating a structure of a general LTE system according to an embodiment of the disclosure.

Referring to FIG. 1, a radio access network of an LTE system may include a next generation base station (an evolved Node B (ENB), a Node B, or a base station) 1-05, 1-10, 1-15, and 1-20, a mobility management entity (MME) 1-25, and a serving-gateway (S-GW) 1-30. A user equipment (UE) (or a terminal) 1-35 accesses an external network via the ENB 1-05 to 1-20 and the S-GW 1-30.

In FIG. 1, the ENB 1-05, 1-10, 1-15, and 1-20 corresponds to a legacy node B in a universal mobile telecommunication system (UMTS) system. The ENB is connected to the UE 1-35 via a wireless channel and performs a more complex role than the legacy node B. In the LTE system, real-time services, such as a voice over IP (VoIP) based on an Internet protocol, and all user traffic may be provided via a shared channel. Accordingly, there is a desire for a device that performs scheduling by collecting state information, such as the buffer states, available transmission power states, channel states, and the like associated with UEs, and the ENB 1-05, 1-10, 1-15, and 1-20 may be in charge of it. A single ENB may generally control a plurality of cells. For example, in order to embody a transmission rate of 100 Mbps, the LTE system may use an orthogonal frequency division multiplexing (OFDM) as a wireless access technology in a bandwidth of 20 megahertz (MHz). Furthermore, the ENB may apply an adaptive modulation and coding (AMC) scheme, which determines a modulation scheme and a channel coding rate based on a channel state of a UE. The S-GW 1-30 is a device for providing a data bearer, and produces or removes a data bearer according to the control by the MME 1-25. The MME is a device that is in charge of various control functions in addition to a mobility management function associated with a UE, and may be connected to a plurality of base stations.

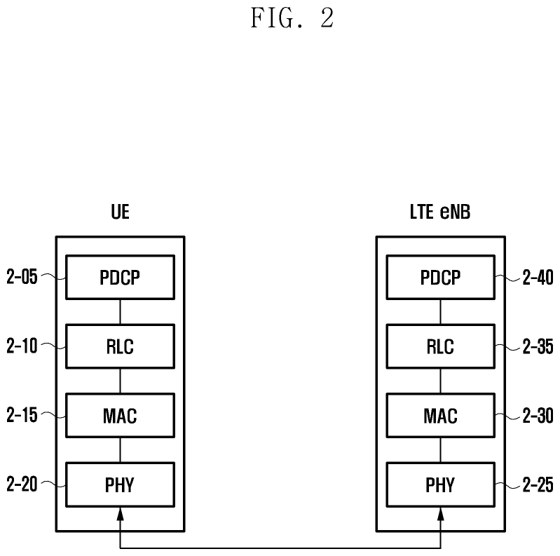

FIG. 2 is a diagram illustrating a radio protocol structure of a general LTE system according to an embodiment of the disclosure.

Referring to FIG. 2, the radio protocol of the LTE system may include a packet data convergence protocol (PDCP) 2-05 and 2-40, a radio link control (RLC) 2-10 and 2-35, a medium access control (MAC) 2-15 and 2-30 for each of a UE and an ENB. A PDCP is in charge of Internet protocol (IP) header compression or decompression, or the like. The main function of the PDCP may be summarized as follows.
Header compression and decompression (header compression and decompression: robust header compression (ROHC) only):
Transfer of user data;
Sequential delivery (in-sequence delivery of upper layer packet data units (PDUs) at PDCP re-establishment procedure for RLC AM);
Reordering (for split bearers in data congestion (DC) (only support for RLC AM): PDCP PDU routing for transmission and PDCP PDU reordering for reception);
Duplicate detection (duplicate detection of lower layer service data units (SDUs) at PDCP re-establishment procedure for RLC AM);
Retransmission (retransmission of PDCP SDUs at handover and, for split bearers in DC, of PDCP PDUs at PDCP data-recovery procedure, for RLC acknowledge mode (AM));
Ciphering and deciphering; and
Timer-based SDU discard (timer-based SDU discard in uplink).

A radio link control (RLC) 2-10 and 2-35 may reconfigure a PDCP packet data unit (PDU) to have an appropriate size and may perform an automatic repeat & request (ARQ) operation or the like. Main functions of the RLC may be summarized as follows.
Data transfer function (transfer of upper layer PDUs);
ARQ function (error correction through automatic repeat & request (ARQ) (only for AM data transfer));
Concatenation, segmentation, and reassembly function (concatenation, segmentation and reassembly of RLC SDUs (only for unacknowledged mode (UM) and AM data transfer));
Re-segmentation function (re-segmentation of RLC data PDUs (only for AM data transfer));
Reordering function (reordering of RLC data PDUs (only for UM and AM data transfer);
Duplicate detection function (duplicate detection (only for UM and AM data transfer));
Error detection function (protocol error detection (only for AM data transfer));
RLC SDU discard function (RLC SDU discard (only for UM and AM data transfer)); and
RLC re-establishment function.

The MAC 2-15 and 2-30 is connected to various RLC layer devices configured for one UE, and multiplexes RLC PDUs to a MAC PDU and demultiplexes RLC PDUs from a MAC PDU. Main functions of the MAC may be summarized as follows.
Mapping function (mapping between logical channels and transport channels);
Multiplexing and demultiplexing function (multiplexing/demultiplexing of MAC SDUs belonging to one or different logical channels into/from transport blocks (TB) delivered to/from the physical layer on transport channels);
Scheduling information reporting function;
Hybrid automatic repeat request (HARQ) function (error correcting through HARQ);
Function of priority adjustment between logical channels (priority handling between logical channels of one UE);
Function of priority adjustment between UEs (priority handling between UEs by means of dynamic scheduling);
MBMS service identification function;
Transport format selection function; and
Padding function.

The physical (PHY) layer 2-20 and 2-25 performs an operation of channel-coding and modulating higher layer data to produce an OFDM symbol and transmitting the OFDM symbol via a wireless channel, or demodulating and channel-decoding an OFDM symbol received via a wireless channel and transferring the same to a higher layer.

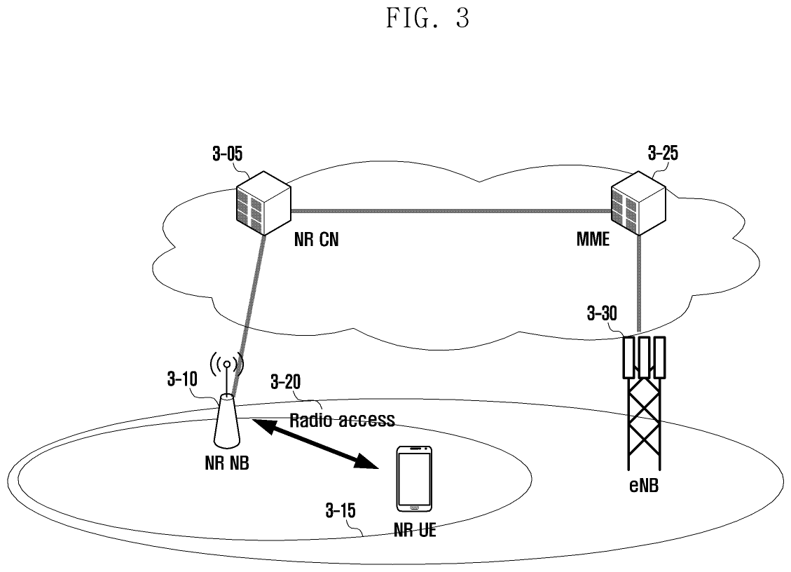

FIG. 3 is a diagram illustrating a structure of a next generation mobile communication system according to an embodiment of the disclosure.

Referring to FIG. 3, a radio access network of a next generation mobile communication system (hereinafter, NR or 5g) may include a next generation base station (new radio node B (hereinafter, an NR gNB or an NR base station)) 3-10 and a next generation radio core network (new radio core network (NR CN)) 3-05. A next generation radio user equipment (new radio user equipment (NR UE) or a UE) 3-15 may access an external network 3-20 via an NR gNB 3-10 and an NR CN 3-05.

In FIG. 3, the NR gNB 3-10 corresponds to an evolved node B (eNB) of a legacy LTE system. The NR gNB is connected to the NR UE 3-15 via a wireless channel, and may provide a better service than a service from a legacy Node B. In the next generation mobile communication system, all user traffic may be serviced via a shared channel. Accordingly, there is a desire for a device that performs scheduling by collecting state information, such as the buffer states, available transmission power states, channel states, and the like associated with UEs, and the NR NB 3-10 may be in charge of the scheduling. A single NR gNB may generally control a plurality of cells. In order to embody ultra-high speed data transmission when compared to a general LTE, a bandwidth greater than or equal to the maximum bandwidth in general may be applied in the next generation mobile communication system. In addition, an orthogonal frequency division multiplexing (OFDM) may be used as a radio access technology and a beamforming technology may be additionally used. Furthermore, an adaptive modulation and coding (hereinafter, referred to as an AMC) scheme that determines a modulation scheme and a channel coding rate based on a channel condition of a UE may be applied. The NR CN 3-05 may perform a function of supporting mobility, configuring a bearer, configuring a QoS, and the like. The NR CN is a device that is in charge of various control functions in addition to a mobility management function associated with a UE, and may be connected to a plurality of base stations. In addition, the next generation mobile communication system may interoperate with an LTE system, and an NR CN may be connected to an MME 3-25 via a network interface. The MME may be connected to an eNB 3-30 which is an LTE base station.

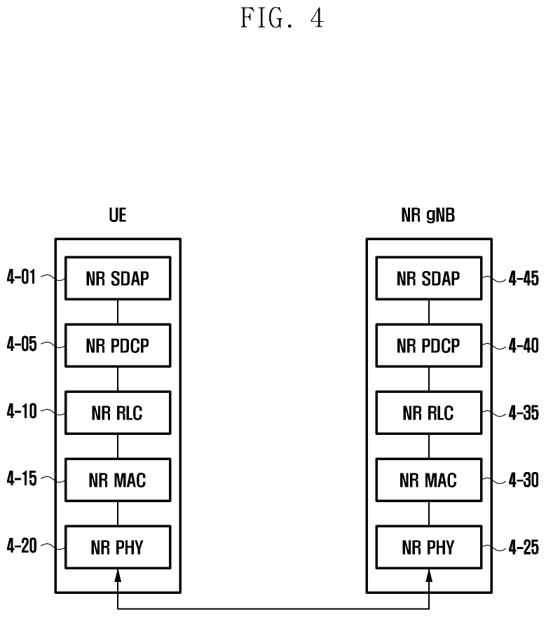

FIG. 4 is a diagram illustrating a structure of a radio protocol of a next generation mobile communication system according to an embodiment of the disclosure.

Referring to FIG. 4, the radio protocol of the next generation mobile communication system may include an NR service data adaptation protocol (SDAP) 4-01 and 4-45, an NR PDCP 4-05 and 4-40, an NR RLC 4-10 and 4-35, an NR MAC 4-15 and 4-30, and an NR PHY 4-20 and 4-25 for each of a UE and an NR gNB.

The main functions of the NR SDAP 4-01 and 4-45 may include at least one of the following functions.
Transfer of user data (transfer or user plane data);
Mapping between a quality of service (QoS) flow and a data bearer in both uplink and downlink (mapping between a QoS flow and a data radio bearer (DRB) for both DL and UL);
Marking a QoS flow ID in both DL and UL packets; and
Mapping reflective QoS flows to data bearers for uplink SDAP PDUs (reflective QoS flow to DRB mapping for the UL SDAP PDUs).

In association with an SDAP layer device, whether to use the header of the SDAP layer device or whether to use the function of the SDAP layer device may be configured for the UE via a radio resource control message for each PDCP layer device, for each bearer, or for each logical channel. If the SDAP header is configured, an indication may be provided via a non-access stratum (NAS) reflective quality of service (QoS) configuration one-bit indicator and an access stratum (AS) reflective QoS configuration one-bit indicator of the SDAP header so that the UE updates or reconfigures mapping information between a QoS flow and a data bearer in an uplink and a downlink. The SDAP header may include QoS flow ID information indicating QoS. QoS information may be used as data processing priority information, scheduling information, or the like for supporting a smooth service.

The main functions of the NR PDCP 4-05 and 4-40 may include some of the following functions.
Header compression and decompression (header compression and decompression: ROHC only):
Transfer of user data;
Sequential delivery (in-sequence delivery of upper layer PDUs);
Non-sequential delivery (out-of-sequence delivery of upper layer PDUs);
Reordering (PDCP PDU reordering for reception);
Duplicate detection (duplicate detection of lower layer SDUs);
Retransmission (retransmission of PDCP SDUs);
Ciphering and deciphering; and
Timer-based SDU discard (timer-based SDU discard in uplink).

In the above-description, the reordering function of the NR PDCP device is a function of sequentially reordering PDCP PDUs received from a lower layer according to a sequence number (SN). The reordering function of the NR PDCP device may include a function of transferring sequentially reordered data to a higher layer or a function of immediately transferring data irrespective of a sequence. In addition, the reordering function may include a function of recording lost PDCP PDUs after sequential recording, a function of reporting the states of lost PDCP PDUs to a transmission side, or a function of requesting retransmission of lost PDCP PDUs.

The main function of the NR RLC 4-10 and 4-35 may include some of the following functions.
Transfer of data (transfer of upper layer PDUs);
Sequential delivery (in-sequence delivery of upper layer PDUs);
Non-sequential delivery (out-of-sequence delivery of upper layer PDUs);
ARQ (error correcting through ARQ);
Concatenation, segmentation, and reassembly (concatenation, segmentation and reassembly of RLC SDUs);
Re-segmentation (re-segmentation of RLC data PDUs);
Reordering (reordering of RLC data PDUs);
Duplicate detection;
Error detection (protocol error detection);
RLC SDU discard; and
RLC re-establishment.

In the above-description, the in-sequence delivery function of the NR RLC device is a function of sequentially transferring RLC SDUs, received from a lower layer, to a higher layer. In the case in which a single original RLC SDU is divided into multiple RLC SDUs and the multiple RLC SUDs are received, the in-sequence delivery function of the NR RLC device may include a function of reassembling and transferring the same.

The in-sequence delivery function of the NR RLC device may include a function of reordering received RLC PDUs according to an RLC sequence number (SN) or a PDCP SN, and a function of recording lost RLC PDUs after sequential reordering. In addition, the in-sequence delivery function may include a function of reporting the states of the lost RLC PDUs to a transmission side, and a function of requesting retransmission of the lost RLC PDUs.

The in-sequence delivery function of the NR RLC device may include a function of sequentially transferring, to a higher layer, only RLC SDUs before a lost RLC SDU in case that a lost RLC SDU is present.

The in-sequence delivery function of the NR RLC device may include a function of sequentially transferring all RLC SDUs, received before a predetermined timer starts, to a higher layer even though a lost RLC SDU is present, in case that the predetermined timer expires.

The in-sequence delivery function of the NR RLC device may include a function of sequentially transferring all RLC SDUs, received up to the present, to a higher layer even though a lost RLC SDU exists, in case that a predetermined timer expires.

The NR RLC device may process RLC PDUs in order of reception, irrespective of a sequence number (out-of-sequence delivery), and may transfer the same to the NR PDCP device.

In the case in which the NR RLC device receives a segment, the NR RLC device receives segments, which are stored in a buffer or which are to be received in the future, reconfigures the segments as a single intact RLC PDU, and transmits the same to the NR PDCP device.

The NR RLC layer may not include a concatenation function. In addition, the concatenation function may be performed in the NR MAC layer or may be replaced with a multiplexing function in the NR MAC layer.

In the above-description, the out-of-sequence delivery function of the NR RLC device is a function of transferring RLC SDUs, received from a lower layer, to a higher layer, irrespective of a sequence. In the case in which a single original RLC SDU is divided into multiple RLC SDUs and the multiple RLC SDUs are received, the out-of-sequence delivery function may include a function of reassembling and transmitting the same. The out-of-sequence delivery function of the NR RLC device may include a function of storing the RLC SN or PDCP SN of received RLC PDUs, sequentially ordering the same, and recording lost RLC PDUs.

The NR MAC 4-15 and 4-30 may be connected to multiple NR RLC layer devices configured for a single UE, and the main functions of the NR MAC may include some of the following functions.
Mapping (mapping between logical channels and transport channels);
Multiplexing and demultiplexing (multiplexing/demultiplexing of MAC SDUs);
Scheduling information reporting;
HARQ (error correcting through HARQ);
Priority handling between logical channels (priority handling between logical channels of one UE);
Priority handling between UEs (priority handling between UEs by means of dynamic scheduling);
MBMS service identification;
Transport format selection; and
Padding.

The NR PHY layer 4-20 and 4-25 may perform channel-coding and modulating of higher layer data to produce an OFDM symbol and transmit the OFDM symbol via a wireless channel, or may perform demodulating an OFDM symbol received via a wireless channel. Via channel decoding, transferring to a higher layer may be performed.

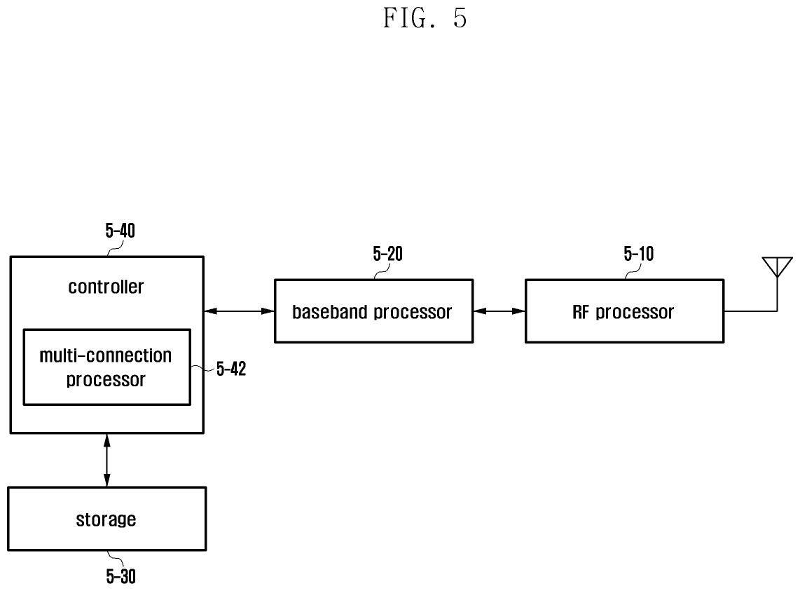

FIG. 5 is a diagram illustrating an internal structure of a UE according to an embodiment of the disclosure.

Referring to FIG. 5, the UE may include a radio frequency (RF) processor 5-10, a baseband processor 5-20, a storage 5-30, and a controller 5-40.

The RF processor 5-10 may perform a function of transmitting or receiving a signal via a wireless channel, such as band conversion and amplification of a signal. The RF processor 5-10 may up-convert a baseband signal provided from the baseband processor 5-20 into an RF band signal so as to transmit the RF band signal via an antenna, and may down-convert an RF band signal received via the antenna into a baseband signal. For example, the RF processor 5-10 may include a transmission filter, a reception filter, an amplifier, a mixer, an oscillator, a digital-to-analog converter (DAC), an analog-to-digital converter (ADC), and the like. Although only a single antenna is illustrated in the embodiment of the disclosure, the UE may include a plurality of antennas. In addition, the RF processor 5-10 may include a plurality of RF chains. Furthermore, the RF processor 5-10 may perform beamforming. For the beamforming, the RF processor 5-10 may control the phase and the size of each of the signals transmitted or received via a plurality of antennas or antenna elements. In addition, the RF processor may perform MIMO and may receive multiple layers when performing an MIMO operation.

The baseband processor 5-20 may execute a function of converting between a baseband signal and a bit string according to the physical layer standard of a system. For example, in the case of data transmission, the baseband processor 5-20 may produce complex symbols by encoding and modulating a transmission bit string. In addition, in the case of data reception, the baseband processor 5-20 may restore a reception bit string by demodulating and decoding a baseband signal provided from the RF processor 5-10. For example, according to an orthogonal frequency division multiplexing (OFDM) scheme, in the case of data transmission, the baseband processor 5-20 may produce complex symbols by encoding and modulating a transmission bit string, may map the complex symbols to subcarriers, and then may configure OFDM symbols via an inverse fast Fourier transform (IFFT) operation and cyclic prefix (CP) insertion. Furthermore, in the case of data reception, the baseband processor 5-20 may divide the baseband signal provided from the RF processor 5-10 in units of OFDM symbols, may reconstruct the signals mapped to the subcarriers via a fast Fourier transform (FFT), and then may reconstruct a received bit string via demodulation and decoding.

The baseband processor 5-20 and the RF processor 5-10 may transmit and receive signals as described above. Accordingly, the baseband processor 5-20 and the RF processor 5-10 may be referred to as a transmitter, a receiver, a transceiver, or a communication unit. Furthermore, at least one of the baseband processor 5-20 and the RF processor 5-10 may include a plurality of communication modules in order to support different multiple radio access technologies. In addition, at least one of the baseband processor 5-20 and the RF processor 5-10 may include different communication modules to process signals of different frequency bands. For example, the different radio access technologies may include a wireless LAN (e.g., IEEE 802.11), a cellular network (e.g., LTE), and the like. In addition, different frequency bands may include a super high frequency (SHF) band (e.g., 2.NRHz, NRhz) and millimeter (mm) wave band (e.g., 60 GHz).

The storage 5-30 may store data such as a basic program, an application program, and configuration information for the operation of the UE. More particularly, the storage 5-30 may store information related to a second access node that performs wireless communication using a second radio access technology. In addition, the storage 5-30 may provide data stored therein by request of the controller 5-40.

The controller 5-40 may control overall operation of the UE. For example, the controller 5-40 may perform transmission or reception of a signal via the baseband processor 5-20 and the RF processor 5-10. In addition, the controller 5-40 may record data in the storage 5-40 and read the data. To this end, the controller 5-40 may include at least one processor. For example, the controller 5-40 may include a communication processor (CP) (i.e., a multi-connection processor 5-42) that performs control for communication and an application processor (AP) that controls a higher layer such as an application program.

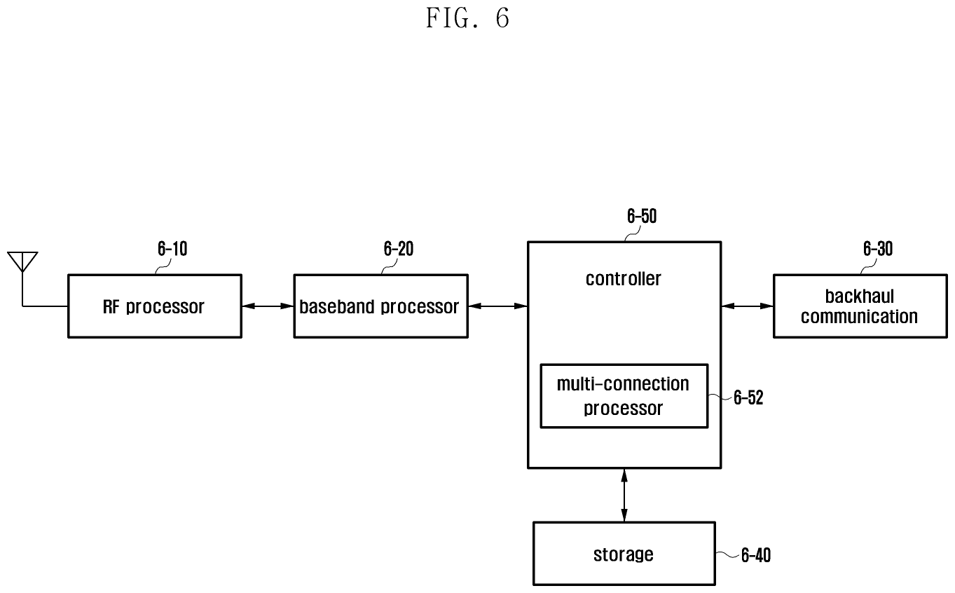

FIG. 6 is a diagram illustrating a configuration of an NR base station according to an embodiment of the disclosure.

Referring to FIG. 6, as illustrated in the drawing, the base station may include an RF processor 6-10, a baseband processor 6-20, a backhaul communication unit 6-30, a storage 6-40, and a controller 6-50.

The RF processor 6-10 may perform a function of transmitting or receiving a signal via a wireless channel, such as band conversion and amplification of a signal. The RF processor 6-10 may up-convert a baseband signal provided from the baseband processor 6-20 into an RF band signal so as to transmit the RF band signal via an antenna, and may down-convert an RF band signal received via the antenna into a baseband signal. For example, the RF processor 6-10 may include a transmission filter, a reception filter, an amplifier, a mixer, an oscillator, a DAC, an ADC, and the like. In the embodiment of the disclosure, although only a single antenna is illustrated, a first access node may include a plurality of antennas. In addition, the RF processor 6-10 may include a plurality of RF chains. Furthermore, the RF processor 6-10 may perform beamforming. For the beamforming, the RF processor 6-10 may control the phase and the size of each of the signals transmitted or received via a plurality of antennas or antenna elements. The RF processor may perform a downlink MIMO operation by transmitting one or more layers.

The baseband processor 6-20 may perform a function for conversion between a baseband signal and a bit string according to the physical layer standard of a first radio access technology. For example, in the case of data transmission, the baseband processor 6-20 may produce complex symbols by encoding and modulating a transmission bit string. In addition, in the case of data reception, the baseband processor 6-20 may restore a reception bit string by demodulating and decoding a baseband signal provided from the RF processor 6-10. For example, according to the OFDM scheme, in the case of data transmission, the baseband processor 6-20 may produce complex symbols by encoding and modulating the transmission bit string, may map the complex symbols to subcarriers, and then may configure OFDM symbols via an IFFT operation and CP insertion. In addition, in the case of data reception, the baseband processor 6-20 may divide a baseband signal provided from the RF processor 6-10 in units of OFDM symbols, may restore signals mapped onto the subcarriers via an FFT operation, and may restore a received bit string via demodulation and decoding. The baseband processor 6-20 and the RF processor 6-10 transmit and receive signals as described above. Accordingly, the baseband processor 6-20 and the RF processor 6-10 may be referred to as a transmitter, a receiver, a transceiver, a communication unit, or a wireless communication unit.

The backhaul communication unit 6-30 may provide an interface for performing the communication with other nodes in a network. The backhaul communication unit 6-30 may convert, into a physical signal, a bit string transmitted from a master base station to another node, for example, a secondary base station, a core network, and the like, and may convert a physical signal received from the other node into a bit string.

The storage 6-40 may store data such as a basic program, an application program, and configuration information for the operation of the primary base station. Particularly, the storage 6-40 may store information associated with a bearer allocated to a connected UE, a measurement result reported from a connected UE, and the like. In addition, the storage 6-40 may store information which is a criterion for determining whether to provide multiple accesses to a UE or to suspend connection. In addition, the storage 6-40 may provide data stored therein by request of the controller 6-50.

The controller 6-50 may control the overall operation of the base station. For example, the controller 6-50 may transmit or receive a signal via the baseband processor 6-20 and the RF processor 6-10, or via the backhaul communication unit 6-30. In addition, the controller 6-50 may record data in the storage 6-40 and may read the data. To this end, the controller 6-50 may include at least one processor (i.e., a multi-connection processor 6-52).

In the case of lower layer triggered mobility (LTM), a network may transfer, to a UE in advance, pieces of configuration information needed for handover, and may indicate, to the UE, performing of handover via a physical layer or MAC CE. In this instance, an operation that the UE performs may change depending on a unit based on which predetermined configuration information is to be transferred to the UE.

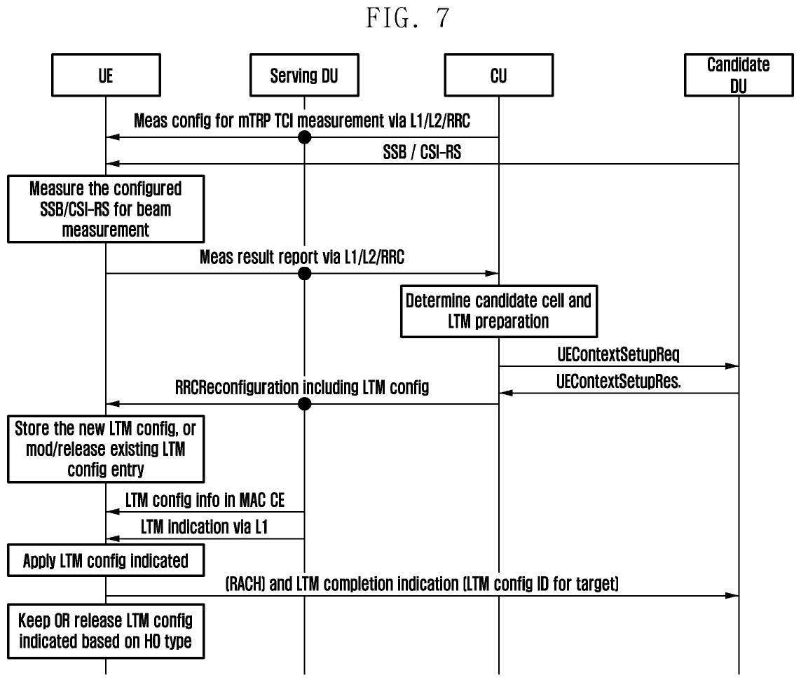

FIG. 7 is a diagram illustrating operation of a UE, a CU, and a DU for an LTM operation according to an embodiment of the disclosure.

Referring to FIG. 7, via a serving cell, a centralized unit (CU) may transfer, to a UE, pieces of information for measuring beams to be measured among beams of neighboring cells, for example, neighboring cells operated by distributed units (DUs) in the same CU. The information may be transferred together with a condition for transmitting a measured result or time information. The information may be given as transmission configuration indicator (TCI) state information. Alternatively, the information may be included in downlink control information (DCI) or a DL medium access control (MAC) control element (CE), and may be transferred.

The UE that receives the information may measure a configured beam of a corresponding neighboring cell. The UE may report a beam measurement result to the CU when a given condition is satisfied or in predetermined cycles.

The CU that receives the report may request, from DUs controlled by the CU, configuration of LTM for predetermined cells operated by the DUs, and may request the configuration information thereof from the DUs. The DU may transfer, to the CU, the configuration information for LTM for the corresponding target cell.

The CU may assign a predetermined ID for the LTM configuration information in a unit of RRCReconfiguration, CellGroupconfiguration, or cell configuration, may associate the LTM configuration information with the configuration information, and may transmit, to the UE, the same in the form of a list. In this instance, a used message may be RRCReconfiguration. The UE that receives the message may store the LTM configuration information including the list included in a variable for LTM.

In case that the UE receives a signal or message indicating performing of LTM with respect to a predetermined LTM target cell from a network, the UE may apply an LTM configuration associated with the target cell. The UE may display completion of application of the LTM configuration or completion of handover (HO).

When transmitting a signal indicating performing of LTM, the network may transmit an ID list of available target cells via an MAC CE in advance so that the UE may perform a predetermined operation

A serving DU may indicate performing of LTM with respect to a predetermined target cell via DCI. In this instance, with respect to the target cells of which information is provided in advance via the MAC CE, the UE may perform DL synchronization or RA first. An indication that indicates performing of LTM via a DCI may include the ID of predetermined LTM, and the UE may perform handover to a target cell corresponding to the ID.

As another embodiment of the disclosure, performing of LTM may be indicated by indicating a predetermined ID by using only MAC CE. Indicating successful performance of handover may be a UL RRC message, a UL MAC CE, or uplink control information (UCI).

After successfully performing LTM HO, the UE may not delete but maintain an existing LTM configuration.

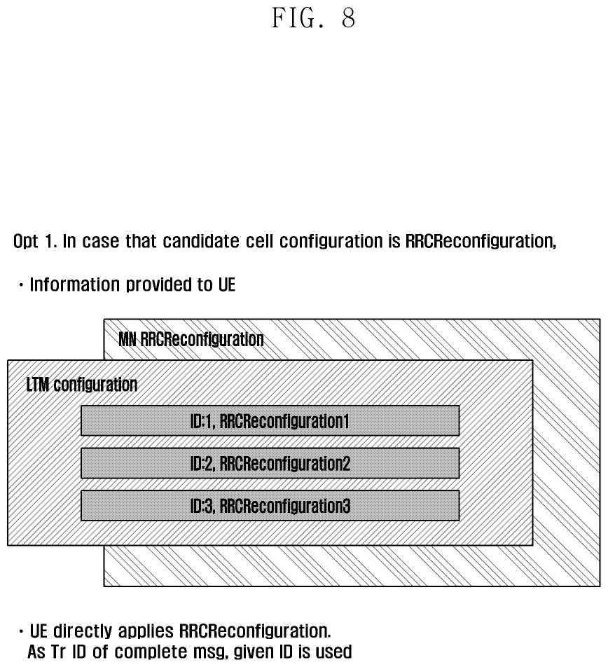

FIG. 8 is a diagram illustrating a case in which a configuration of a candidate cell corresponds to RRCReconfiguration according to an embodiment of the disclosure.

Referring to FIG. 8, in opt 1. In case that a candidate cell configuration is determined in a unit of RRCReconfiguration:

Configuration: a CU may determine LTM and may determine a target candidate cell. The CU may transmit, to a DU that operates the target candidate cell, a UEContextSetupRequest message or a UE-associated F1-AP message. The message may include at least one of the following.
An LTM indicator or field (new) or an existing conditional inter-DU mobility information IE;
An indicator indicating LTM initiation or replace or modification may be added to the LTM indicator or field;
A target SPcell ID (in case that an existing CU has a mapped ID of a cell operated by a DU) or a SPcell NR CGI;
A source cell configuration or reference configuration (optional);
The configuration may be RRCReconfiguration included in AS-Config included in an HandoverPreparation IE.

The DU may receive the message, and may determine whether to grant the same. In case that it is granted, any one piece of information among the following may be included in a UEContextSetupResponse message.
An LTM indicator/field;
An LTM initiation or replace or modification indicator may be added.
A requested (or prepared) SPcell ID (in case that an existing CU has a mapped ID of a cell operated by a DU) or a requested (or prepared) SPcell NR CGI;

A target cell configuration (full configuration or delta configuration);
A delta configuration (a delta configuration indicator may be included) in case that UEContextSetupRequest includes a source or reference configuration;
A full configuration (a full configuration indicator may be included) in case that UEContextSetupRequest does not include a source or reference configuration;
The target cell configuration may be included in an RRC container; and
The target cell configuration information may be CellGroupConfig, and may be included in an octet string format.

The CU that receives the response message may configure an RRCReconfiguration message by including the corresponding CellGroupConfig in a master cell group (MCG) configuration. The CU may include the message in a container for LTM of RRCReconfiguration of an MN format and transmit the same to a UE. The RRCReconfiguration message included in the LTM container may be associated with the ID of an integer allocated by the CU. The LTM container may include, in an entry, the association between multiple IDs and RRCReconfiguration messages of candidate target cells.

The UE that receives the RRCReconfiguration of the MN format may produce a variable for the LTM container, and may store the IDs and an RRCReconfiguration list associated with ID.

Triggering together with a predetermined ID may be transmitted from a network to the UE via a MAC CE or DCI. The UE that receives the signal may apply RRCReconfiguration of the corresponding ID. In case that RRCReconfiguration including a predetermined indicator (e.g., indicating inter-CU HO) as opposed to indicating performing of LTM, or including a reconfigurationWithSync field is received, or in case that conditional handover (CHO) is successfully performed, the UE may delete content included in the corresponding LTM variable. Alternatively, the network may always include an LTM configuration release indicator in a HO command for inter-CU HO. In case that LTM is successfully performed, the UE may delete the whole or a part of the content of the LTM container configured by a source CU.

The UE may indicate successful HO while transmitting an RRCReconfigurationComplete message to a target cell. In this instance, as a transaction ID, the RRCReconfigurationComplete message may use a transaction ID included in the RRCReconfiguration message of the corresponding target cell. In addition, the complete message may include LTM configuration information ID of the target cell.

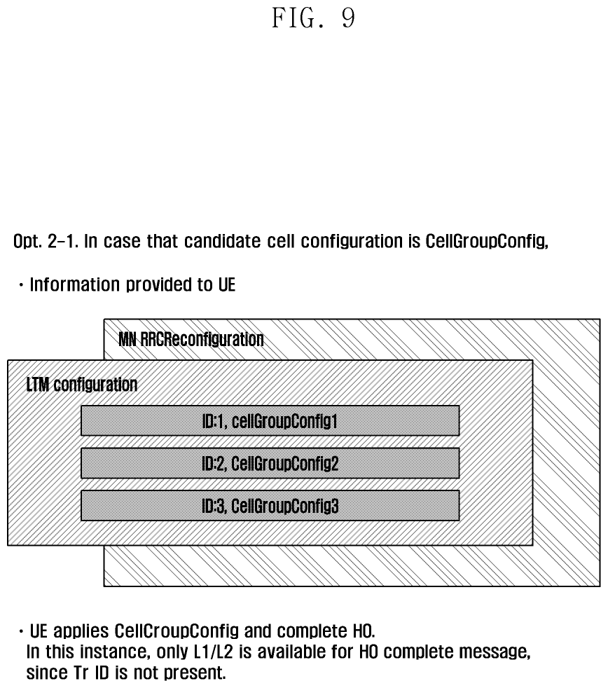

FIG. 9 is a diagram illustrating a case in which a configuration of a candidate cell corresponds to a cell group configuration according to an embodiment of the disclosure.

Referring to FIG. 9, in opt 2. In case that a candidate cell configuration is determined in a unit of CellGroupConfig

Configuration: a CU may determine LTM, and may determine a target candidate cell. The CU may transmit, to a DU that operates the target candidate cell, a UEContextSetupRequest message or UE-associated F1-AP message. The message may include at least one of the following.
An LTM indicator or field (new) or an existing conditional inter-DU mobility information IE;
An indicator indicating LTM initiation or replace or modification may be added to the LTM indicator or field.
An indicator indicating replace or modification may be displayed when a change in the source or reference configuration for SPcell assigned with the existing LTM config ID is present after initial preparation.
A target SPcell ID (in case that an existing CU has a mapped ID of a cell operated by a DU) or SPcell NR CGI;
A source cell configuration or reference configuration (optional); and
The configuration may be RRCReconfiguration included in AS-Config included in an HandoverPreparation IE.

The DU may receive the message, and may determine whether to grant the same. In case that it is granted, any one piece of information among the following may be included in UEContextSetupResponse or an F1-AP message.
An LTM indicator or field; and
An LTM initiation or replace or modification indicator may be added.
In case that a message corresponding to UEContextSetupReq is received or in case that a change of the existing candidate cell configuration is needed by request of the DU itself, a replace or modification indicator may be displayed.
A requested (or prepared) SPcell ID (in case that an existing CU has a mapped ID of a cell operated by a DU) or requested (or prepared) SPcell NR CGI;
A target cell configuration (full configuration or delta configuration);
A delta configuration (a delta configuration indicator may be included) in case that UEContextSetupRequest includes a source or reference configuration; and
A full configuration (a full configuration indicator may be included) in case that UEContextSetupRequest does not include a source or reference configuration.
The configuration may be included in an RRC container.
The configuration information may be CellGroupConfig, and may be included in an octet string format.

The CU that receives the response message may associate the corresponding CellGroupConfig with an ID of an integer, may include the same in a container for LTM of RRCReconfiguration of an MN format, and may transmit the same to a UE. The LTM container may include, in an entry, the association between multiple IDs and CellGroupConfig messages of candidate target cells.

The UE that receives the RRCReconfiguration of the MN format may produce a variable for an LTM container, and may store the IDs and an CellGroupConfig list associated with the IDs.

Triggering together with a predetermined ID may be transmitted from a network to the UE via a MAC CE or DCI. The UE that receives the signal may apply CellGroupConfig of the corresponding ID. In case that RRCReconfiguration including a predetermined indicator (e.g., an indicator indicating inter-CU HO) as opposed to indicating performing of LTM or including a reconfigurationWithSync field is received, or in case that CHO is successfully performed, the UE may delete content included in the corresponding LTM variable. Alternatively, the network may always include an LTM configuration release indicator in a HO command for inter-CU HO. In case that LTM is successfully performed, the UE may delete the whole or a part of the content of the LTM container configured by a source CU. In case that the UE successfully performs or completes handover to a target cell indicated, a handover complete indicator may be transmitted to the target cell. The indicator may be transmitted via a UCI or a UL MAC CE. Alternatively, the indicator may be transmitted via a separate RRC UL message. In the UCI or MAC CE or UL RRC message, an LTM configuration ID of the successful target cell may be included.

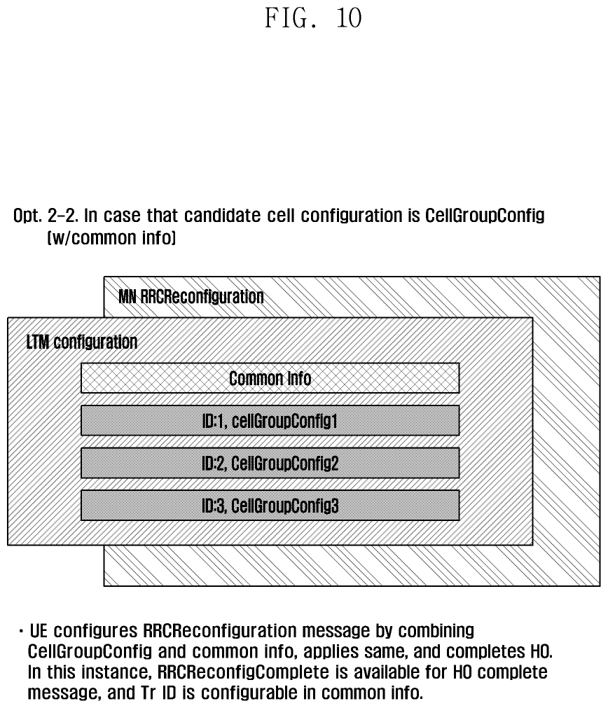

FIG. 10 is a diagram illustrating a case in which a configuration of a candidate cell corresponds to a cell group configuration, and common configuration information is maintained separately according to an embodiment of the disclosure.

Referring to FIG. 10, in configuration: a CU may determine LTM, and may determine a target candidate cell. The CU may transmit, to a DU that operates the cell, a UEContextSetupRequest message or a UE-associated F1-AP message, and the message may include at least one of the following.
An LTM indicator or field (new) or an existing conditional inter-DU mobility information IE; and
An indicator indicating LTM initiation or replace/modification may be added to the LTM indicator or field.
An indicator indicating replace or modification may be displayed when a change in the source or reference configuration for SPcell assigned with the existing LTM config ID is present after initial preparation.
A target SPcell ID (in case that an existing CU has a mapped ID of a cell operated by a DU) or SPcell NR CGI;
A source cell configuration or reference configuration (optional); and
The configuration may be RRCReconfiguration included in AS-Config included in an HandoverPreparation IE.

The DU may receive the message, and determines whether to grant the same. In case that it is granted, any one piece of information among the following may be included in UEContextSetupResponse or an F1-AP message.
An LTM indicator or field; and
An LTM initiation or replace or modification indicator may be added.
In case that a message corresponding to UEContextSetupReq is received or in case that a change of the existing candidate cell configuration is needed by request of the DU itself, a replace or modification indicator may be displayed.
A requested (or prepared) SPcell ID (in case that an existing CU has a mapped ID of a cell operated by a DU) or requested (or prepared) SPcell NR CGI;
A target cell configuration (full configuration or delta configuration);
A delta configuration (a delta configuration indicator may be included) in case that UEContextSetupRequest includes a source or reference configuration; and
A full configuration (a full configuration indicator may be included) in case that UEContextSetupRequest does not include a source or reference configuration.
The configuration may be included in an RRC container; and
The configuration information may be CellGroupConfig, and may be included in an octet string format.

The CU that receives the response may associate the corresponding CellGroupConfig with an ID of an integer, may include the same in a container for LTM of RRCReconfiguration of an MN format. The LTM container may include, in an entry, association between multiple IDs and CellGroupConfig messages of candidate target cells.

The CU may transfer the list of CellGruopConfig via the MN format RRCReconfiguration. At least one piece of information among information included in other RRCReconfiguration (e.g., information excluded from cellGroupConfig) applied in common, for example, radioBearerConfig, measConfig, fullConfig, otherConfig, dedicatedSIB1-delivery, dedicatedSystemInformationDelivery, dedicatedNAS-MessageList, and masterKeyUpdate information may be included in the list of CellGroupConfig. In case that LTM HO is successfully performed, the field may include RRCReconfigurationComplete or a transaction ID to be used for a UL RRC message when successful performance is indicated to a target cell.

A UE that receives the RRCReconfiguration of the MN format may produce a variable for an LTM container, and may store IDs and a CellGroupConfig list associated with the IDs.

Triggering together with a predetermined ID may be transmitted from a network to the UE via a MAC CE or DCI. The UE that receives the signal may apply CellGroupConfig of the corresponding ID and the configuration of the common information field. The UE may configure RRCReconfiguration including CellGroupConfig information and common information, and may apply the corresponding RRCReconfiguration. In case that RRCReconfiguration including a predetermined indicator (e.g., inter-CU HO) or a reconfigurationWithSync field is received, or in case that CHO is successfully performed, the UE may delete content included in the corresponding LTM variable. In case that the UE successfully performs or completes handover to a target cell indicated, an indicator indicating a successful handover may be transmitted to the target cell. The indicator may be transmitted via a UCI or a UL MAC CE. Alternatively, the indicator may be transmitted via a separate RRC UL message. Alternatively, the indicator may be an RRCReconfigurationComplete message. In case that a transaction ID is configured in a common field, the transaction ID may be used for the RRCReconfigurationComplete message indicating successful performance and transmitted to the target cell. The RRCReconfigurationComplete or the UCI or MAC CE may include the LTM configuration ID of the successful target cell.

According to another embodiment of the disclosure, there may be a limited number of target cells to which the common field is applied. For example, a common field applied to a predetermined target cell configuration CellGroupConfig may be a predetermined one among multiple common fields, and a network may transmit a multi-common configuration information list and a multi-target candidate CellGroupConfig list via an LTM container when configuration is performed for a UE. In this instance, a predetermined common configuration may be associated with a predetermined target candidate CellGroupConfig, and may be transmitted to the UE. There are suggested following two association methods.

Case 1. An ID is allocated to each common configuration, and an ID is allocated to each target candidate CellGroupConFIG. An ID applied to a common configuration may be unique in a common configuration list, and an ID applied to a candidate target CellGroupConfig may be unique in a candidate target CellGroupConfig list. Information that associates a common ID with a target CellGroupConfig ID may be transferred to the UE via a separate field.

Case 2. An ID is assigned only to a common configuration, and an ID of a common configuration to be applied to each candidate target CellGroupConfig may be indicated. Alternatively, an ID is assigned to candidate target CellGroupConfig, and an ID of candidate target CellGroupConfig to which a common configuration is to be applied may be indicated in the common configuration. In this instance, there is a need of an F1-AP signal supplement.

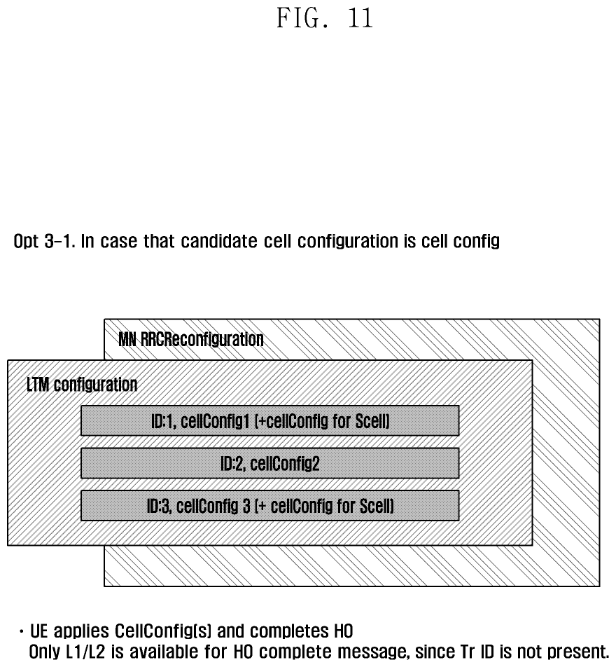

FIG. 11 is a diagram illustrating a case in which a configuration of a candidate cell corresponds to a cell configuration according to an embodiment of the disclosure.

Referring to FIG. 11, in opt 3. In case that a candidate configuration is given in a unit of a cell;

Configuration: a CU may determine LTM, may determine a target candidate cell, and may transmit, to a DU operating the corresponding cell, a UEContextSetupRequest message or UE-associated F1-AP message, and the message may include at least one piece of information among the following.
An LTM indicator or field (new) or an existing conditional inter-DU mobility information IE;
An indicator indicating LTM initiation or replace or modification may be added to the LTM indicator or field.
A target SPcell ID (in case that an existing CU has a mapped ID of a cell operated by a DU) or SPcell NR CGI;
A source cell configuration or reference configuration (optional), and in the case of a reference configuration, a reference recognition indicator is needed.
The configuration may be RRCReconfiguration included in AS-Config included in an HandoverPreparation IE.

The DU may receive the message and may determine whether to grant the same. In case that it is granted, at least one piece of information among the following may be included in a UEContextSetupResponse message.
An LTM indicator or field;
An LTM initiation or replace or modification indicator may be added.
A requested (or prepared) SPcell ID (in case that an existing CU has a mapped ID of a cell operated by a DU) or requested (or prepared) SPcell NR CGI;
A target cell configuration (full configuration or delta configuration);
A delta configuration (a delta configuration indicator may be included) in case that UEContextSetupRequest includes a source or reference configuration;
A full configuration (a full configuration indicator may be included) in case that UEContextSetupRequest does not include a source or reference configuration;
The configuration may be included in an RRC container.
The configuration information may be a cell configuration or ServingCellConfig or SPcellConfig, and may be included in an octet string format. The cell configuration may be a candidate SPcell configuration.
Scell information that is associated with the cell configuration and is to be added/changed may be included in separate cell config and may be transmitted to the CU.

The CU that receives the response may associate an ID with the corresponding Cell config or spcellConfig and an added cell configuration associated therewith, may include the same in a container for LTM of RRCReconfiguration of an MN format, and may transmit the same to a UE.

The UE that receives the RRCReconfiguration of the MN format may produce a variable for an LTM container, and may store IDs and a CellConfiguration(s) list associated with the IDs.

In case that triggering together with a predetermined ID is signaled from a network to the UE via a MAC CE and/or DCI, CellConfiguration(s) of the corresponding ID may be applied. In case that RRCReconfiguration including a predetermined indicator (e.g., indicating inter-CU HO) or a reconfigurationWithSync field is received, or in case that CHO is successfully performed, the UE may delete content included in the corresponding LTM variable.

In case that the UE successfully performs or completes handover to a target cell indicated, the UE may transmit a successful handover or handover complete indicator to the target cell. The indicator may be transmitted via a UCI or a UL MAC CE. Alternatively, the indicator may be transmitted via a separate RRC UL message. In the UCI or MAC CE or UL RRC message, an LTM configuration ID of the successful target cell may be included.

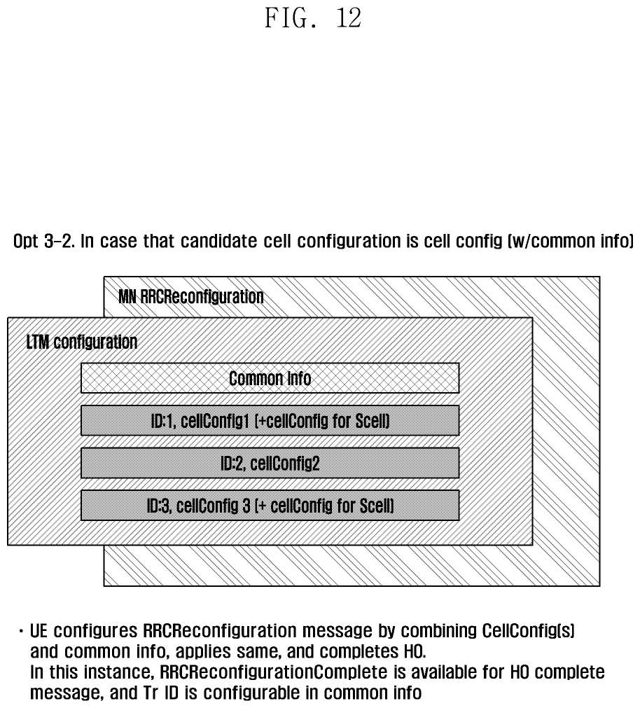

FIG. 12 is a diagram illustrating a case in which a configuration of a candidate cell corresponds to a cell configuration, and common configuration information is maintained separately according to an embodiment of the disclosure.

Referring to FIG. 12, in configuration: a CU may determine LTM and may determine a target candidate cell. The CU may transmit, to a DU operating the target candidate cell, a UEContextSetupRequest message or UE-associated F1-AP message. The message may include at least one piece of information among the following.
An LTM indicator or field (new) or an existing conditional inter-DU mobility information IE;
An indicator indicating LTM initiation or replace or modification may be added to the LTM indicator or field.
A target SPcell ID (in case that an existing CU has a mapped ID of a cell operated by a DU) or SPcell NR CGI;
A source cell configuration or reference configuration (optional), and in the case of a reference configuration, a reference recognition indicator is needed.
The configuration may be RRCReconfiguration included in AS-Config included in an HandoverPreparation IE.

The DU may receive the message, and may determine whether to grant the same. In case that it is granted, at least one piece of information among the following may be included in UEContextSetupResponse or a corresponding F1-AP message.
An LTM indicator or field;
An LTM initiation or replace or modification indicator may be added.
A requested (or prepared) SPcell ID (in case that an existing CU has a mapped ID of a cell operated by a DU) or a requested (or prepared) SPcell NR CGI;
A target cell configuration (full configuration or delta configuration);
A delta configuration (a delta configuration indicator may be included) in case that UEContextSetupRequest includes a source or reference configuration;
A full configuration (a full configuration indicator may be included) in case that UEContextSetupRequest does not include a source or reference configuration.
The configuration may be included in an RRC container.
The configuration information may be a cell configuration or ServingCellConfig/spcellConfig, and may be included in an octet string format. The cell configuration may be a candidate SPcell configuration.
Scell information that is associated with the cell configuration and is to be added or changed may be included in separate cell config and may be transferred to the CU.

The CU that receives the response may associate an ID with the corresponding Cell config or spcellConfig and an added cell configuration associated therewith, may include the same in a container for LTM of RRCReconfiguration of an MN format, and may transmit the same to a UE.

In another embodiment of the disclosure, in addition to the cell configuration, the CU may include information needed for RRCReconfiguration (e.g., information excluded from ServingCellConfig in RRCReconfiguration) as a common field in RRCReconfiguration. For example, the LTM field may include the common field and a list of ID and cell configuration(s) pairs. The pieces of information may be included in MN RRCReconfiguration and may be transmitted to the UE. According to another embodiment of the disclosure, there may be a limited number of target cells to which a common field is applied. For example, a common field applied to a predetermined target cell configuration may be a predetermined one among multiple common fields, and a network may transmit a multi-common configuration information list and a multi-target candidate cell configuration list via an LTM container when configuration is performed for the UE. In this instance, a predetermined common configuration and a predetermined target candidate configuration are associated with each other, and may be transmitted to the UE. There are suggested following two association methods.

Case 1. An ID is allocated to each common configuration, and an ID is allocated to each target candidate cell configuration. An ID applied to a common configuration is unique in a common configuration list, and an ID applied to a candidate target cell configuration is unique in a candidate target cell configuration list. Information that associates a common ID with a target cell config ID may be transmitted to the UE via a separate field.

Case 2. An ID is assigned only to a common configuration, and an ID of a common configuration to be applied to each candidate target cell configuration may be indicated. Conversely, an ID is assigned to a candidate target cell configuration, and an ID of a candidate target cell configuration to which a common configuration is to be applied may be indicated in the common configuration. In this instance, there is a need of an F1-AP signal supplement.

In case that the information is transferred, the UE may receive an LTM performance indication that considers a common field and a cell configuration of a predetermined ID as a single RRCReconfiguration. The UE that receives the LTM performance indication may apply a corresponding RRCReconfiguration, and, in case that a transaction ID is included in an LTM configuration, the UE may transmit an RRCReconfigurationCompelte message to a target cell by using the corresponding transaction ID. In case that successful HO is transmitted by using a MAC CE or a UCI, instead of RRC, the corresponding message may include an LTM triggered config ID.

In association with all the above-described embodiments of the disclosure, in case that the UE receives RRCReconfiguration or performs LTM handover, the UE may check compliance. Via the compliance check, the UE may identify whether configuration information that is received or to be performed is applicable.

The point in time at which checking is available may be one of the following three cases.
1) the case in which RRCReconfiguration including an LTM configuration is received;
2) the case in which performance of LTM HO is indicated by a network in the state in which an LTM configuration is received; and
3) the case in which it depends on implementation by a UE;

More particularly, in the case of 2), when the UE is incapable of complying with the whole or a part of RRCReconfiguration received via SRB1 (e.g., in case that the received RRCReconfiguration message is not a part of a conditional reconfiguration), the UE may determine whether the received RRCReconfiuration message is a part of an LTM configuration. In case that it is received as a part of the LTM configuration, an RRC configuration that is before LTM was performed, before performance of LTM was indicated, or before dynamic cell switch command was provided, may be applied.

The following operation may be needed for operation of the UE.

```
  1> else if RRCReconfiguration is received via NR (i.e., NR standalone,
NE-DC, or NR-DC):
  2> received SRB3 part omitted
  2> else if the UE is unable to comply with (part of) the configuration
included in the RRCReconfiguration message received over the SRB1
    3> if the RRCReconfiguration message was received as part of
ConditionalReconfiguration:
      4> continue using the configuration used prior to when the
inability to comply with the RRCReconfiguration message was detected;
    3> else if the RRCReconfiguration message was received as part of
LTM configuration:
      4> continue using the configuration used prior to dynamic
cell switch execution
    3> else
      4> continue using the configuration used prior to the
reception of RRCReconfiguration message;
    3> if AS security has not been activated:
      4> perform the actions upon going to RRC_IDLE as specified
in 5.3.11, with release cause ‘other’
    3> else if AS security has been activated but SRB2 and at least
one DRB or multicast MRB or, for IAB, SRB2, have not been setup:
      4> perform the actions upon going to RRC_IDLE as specified
in 5.3.11, with release cause ‘RRC connection failure’;
    3> else:
      4> initiate the connection re-establishment procedure as
specified in 5.3.7, upon which the reconfiguration procedure ends;
```

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks, such as the Internet, intranet, local area network (LAN), a wide LAN (WLAN), and storage area network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
receiving, from a base station, a radio resource control (RRC) message including lower layer triggered mobility (LTM) configuration information, the LTM configuration information being associated with at least one RRC reconfiguration;
receiving, from the base station, a medium access control (MAC) control element (CE) for triggering a LTM handover, the MAC CE including an identifier (ID) corresponding to one of the at least one RRC reconfiguration; and
performing the LTM handover to a target cell based on the one of the at least one RRC reconfiguration.

2. The method of claim 1, further comprising:
in case that the RRC message including the LTM configuration information is received, performing a compliance check based on the LTM configuration information.

3. The method of claim 2, wherein the compliance check is performed before the LTM handover.

4. The method of claim 1, further comprising:
transmitting, to the target cell, a complete message based on the ID.

5. A method performed by a base station in a wireless communication system, the method comprising:
transmitting, to a terminal, a radio resource control (RRC) message including lower layer triggered mobility (LTM) configuration information, the LTM configuration information being associated with at least one RRC reconfiguration; and
transmitting, to the terminal, a medium access control (MAC) control element (CE) for triggering a LTM handover to a target cell based on one of the at least one RRC reconfiguration, the MAC CE including an identifier (ID) corresponding to the one of the at least one RRC reconfiguration.

6. The method of claim 5,
in case that the RRC message including the LTM configuration information is transmitted, wherein a compliance check based on the LTM configuration information is performed.

7. The method of claim 6, wherein the compliance check is performed before the LTM handover.

8. The method of claim 5, further comprising:
receiving, from the terminal, a complete message based on the ID.

9. A terminal in a wireless communication system, the terminal comprising:
a transceiver, and
at least one processor coupled with the transceiver, the at least one processor configured to:
receive, from a base station, a radio resource control (RRC) message including lower layer triggered mobility (LTM) configuration information, the LTM configuration information being associated with at least one RRC reconfiguration,
receive, from the base station, a medium access control (MAC) control element (CE) for triggering a LTM handover, the MAC CE including an identifier (ID) corresponding to one of the at least one RRC reconfiguration, and
perform the LTM handover to a target cell based on the one of the at least one RRC reconfiguration.

10. The terminal of claim 9, wherein the at least one processor is further configured to:
in case that the RRC message including the LTM configuration information is received, perform a compliance check based on the LTM configuration information.

11. The terminal of claim 10, wherein the compliance check is performed before the LTM handover.

12. The terminal of claim 9, wherein the at least one processor is further configured to:
transmit, to the target cell, a complete message based on the ID.

13. A base station in a wireless communication system, the base station comprising:
a transceiver, and
at least one processor coupled with the transceiver, the at least one processor configured to:
transmit, to a terminal, a radio resource control (RRC) message including lower layer triggered mobility (LTM) configuration information, the LTM configuration information being associated with at least one RRC reconfiguration, and
transmit, to the terminal, a medium access control (MAC) control element (CE) for triggering a LTM handover to a target cell based on one of the at least one RRC reconfiguration, the MAC CE including an identifier (ID) corresponding to the one of the at least one RRC reconfiguration.

14. The base station of claim 13,
wherein, in case that the RRC message including the LTM configuration information is transmitted, a compliance check based on the LTM configuration information is performed, and
wherein the compliance check is performed before the LTM handover.

15. The base station of claim 13, wherein the at least one processor is further configured to:
receive, from the terminal, a complete message based on the ID.
